(19) United States
(12) Patent Application Publication
(10) Pub. No.: US 2004/0154020 A1
(43) Pub. Date: Aug. 5, 2004

(54) Component oriented and system kernel based process pool/thread pool managing method

(76) Inventors: Rong Chen, Shanghai (CN); Qinghong Lin, Shanghai (CN); Longchuan Lv, Shanghai (CN); Zhicheng Chen, Shanghai (CN); Zhulin Lian, Shanghai (CN)

Correspondence Address: RABIN & BERDO, P.C., Suite 500, 1101 14th Street, N.W., Washington, DC, 20005, US

(21) Appl. No.: 10/747,315

(22) Filed: Dec. 30, 2003

(30) Foreign Application Priority Data
Dec. 31, 2002 (CN) 02160136.4

(51) Int. Cl. G06F 9/00

(52) U.S. Cl. 718/107

(57) ABSTRACT

A component oriented and system kernel based process pool/thread pool managing method, in which, the process pool/thread pool managing assembly is set in computer operation system kernel for managing the component-wise process object/thread object stored in system thread pool, the managing includes the setup of operation environment of process /thread; each thread object includes a work routine object, in time of system creating the thread object, it also creates a work routine object suitable to the environment. It is utilized in the “component oriented” programming environment, effective for safety and rapid creating/exiting from the process/thread, in this way, the occupied system time could be cut-down, and the network data safety could be improved.

### FIELD OF THE INVENTION

The present invention relates to a process pool and thread pool managing function realization method in computer operation system, especially relates to a process pool or thread pool managing method, which is realized in operation system kernel, for fast and safely creating, running and exiting from the process or thread in object oriented way.

### BACKGROUND OF THE INVENTION

The concept of process and thread exists in any computer operation system and is very important, the process and thread managing is an indispensable part to operation system, its managing mechanism quality relates directly to the operation efficiency and the realized service function of overall system. In the known operation system (MSDos/JUnix/Linux/Windows as below), the process means the application program or executable program module in system and its operation environment. For executing program, it needs generally to create address space, allocate the storage pile and sharing code module, whether the program code quantity needed for process execution itself is large or small, all the works needs to be completed in system step by step before executed in true program entry point, and part of system resources are thus occupied, e.g. storage and CPU time. When the process is ended, they are released respectively in reverse order, and this also occupies the CPU time.

In the known system, the thread means generally to execute a code section in a special process environment and provide an execution environment for it. For executing code, it need to create a stack and a control block containing the context, and this occupies also a part system resources, such as storage and CPU time, moreover, it occupies also a part of address and code module attributed to the process, whether the thread executing period is long or short, these works are to be completed in process or system step by step before executed in true code entry point. When the thread is ended, they are released respectively in reverse order, and this also occupies the CPU time.

The operation system of component mode frequently relates with the dynamic creating of process and /or thread, and after program execution completed, the process program needs to be downloaded or the thread execution environment needs to be arranged. In the component oriented programming model, because the invoking back functions caused by service interface function or event starting in each service component are all invoked by mode of thread, so the thread starting and exiting are relative frequently, if the managing efficiency of thread is too low in this stage, the total operation system property may be greatly affected, and this even may lead to a bottleneck problem of system efficiency.

For reasons above, the thread pool concept is used in resent developed Visual Studio.Net (short in Net below) from the Microsoft, and the class managing of thread pool is realized to solve the problem of low system efficiency caused by frequent creating/exiting from thread, however, the thread pool managing from the Microsoft didn't use the C++ language, and the thread pool managing didn't realized by component mode in operation system kernel either. Although there is concept of process pool /thread pool in some special system software, e.g. some mail transceiver servers use the pool for managing, but its realization isn't in the system kernel, and not in the component oriented programming environment either. Moreover, there isn't any report about the process pool /thread pool managing realized by component mode in system kernel within the known computer operation system at present.

Said process pool/thread pool managements are mainly computer system oriented. Another important problem is: along with the operation systems move gradually to network application from desktop, in the Internet operation system of next generation, the needs to dynamically remote creating/running/exiting from process /thread in network environment are more increased, and this relates to the computer safety. These works are mainly concentrated in “Network managing software” at present, however its essence is merely some application programs in operation system, but the safe certifying of request to remote computer creating/running/exiting from process /thread and relative services are not realized and supported in the “system managing software”, i.e. the operation system, and some lawbreakers had chance to steal the network data with no-professional means, in this way, the network safety problem couldn't be completely solved.

### BRIEF DESCRIPTION OF THE INVENTON

The purpose of present invention is providing a obtaining and executing method of component oriented and system kernel based process /thread pool managing and application program object, it could realize the safety and rapid creating/running/exiting from process/thread, the system time utilizing efficiency and network service safety could be improved.

Another purpose of present invention is providing a obtaining and executing method of component oriented and system kernel based process /thread pool managing and application program object, it could cut down greatly the time of creating/exiting from process/thread and the occupied time, the operation efficiency could be improved.

Another purpose of present invention is providing a obtaining and executing method of component oriented and system kernel based process /thread pool managing and application program object, it aims at the operation managing of “process object/thread object”, and is different to the concept of prior operation system “process /thread “, in here, the former is a static component concept, but the latter is a operation program concept; with the property of pool buffer storage, when the process /thread has been stopped but before its object released, the attribute of process object/thread object could be accessed.

The said purposes in present invention are realized by the following technologies: with the process pool and thread pool concept, the original leading role of user program is changed. The system provides a managing component, i.e. process pool, which manages all the resources needed to the process, and records the attributes of each process; in exiting from the process, recovers the used resources. For each process object, system provides a thread pool managing assembly, it manages the resource utilization of every thread attributed to this process, and records the attributes of each thread object, after thread execution, the thread pool arranges the resource. All the managing function program codes of system process pool and thread pool are realized in the operation system kernel, and this makes it more difficulty to decrypt the system program and key to steal network data by lawbreaker. In the thread local/remote creating/accessing/exiting, the “work routine” (work routine) concept is applied in component oriented programming environment, so the safety of network computer is increased, and the computing model is improved. The process pool managing assembly/thread pool managing assembly itself is a component-wise system component.

In concrete, the process pool managing assembly and thread pool managing assembly are basic managing assembly of total operation system with a certain managing function comparing with the general system assembly and application program. The process pool managing assembly is structured in the initialization stage of operation system kernel, and the system already has a process pool managing assembly sample after the total system starting. In this process pool managing assembly sample, certain pieces of process object have been created in advance, and the environments needed for the operation are set in default mode, mainly including: requesting a section of address space, creating the storage pile and generating the sharing code module, and the basic attributes of process object in pool are set in default way, e.g. the schedule priority of process. The so called “pieces” could be statically set by modifying the head file or setting the file, or be dynamically set by system function invoking, it is called “process pool volume” in program designing. The process pool managing assembly has at least two element methods of allocating and releasing, and two element variables of pool volume and actual utilizing pieces as explained below.

The managing to an object in pool from the process pool managing assembly is realized through a queue maintaining, and the process object is an element of the queue. Two methods are provided in present invention for user creating a process, i.e. one is invoking the system API function (in Herschel: ZeeCreateProcess( )), and another is creating through the interfacing method (ISystem:: CreateProcess( )) of current system object. When the user program is executed to where of creating process function/method, the system doesn't create directly a process object, but allocates dynamically a usable process object sample by the process pool managing assembly allocation method. The realization mode of allocation method is: check first if there is any process initialized but not actually used yet in the process pool, if has any one (the allocated process object sample quantity in pool <maximum process sample quantity in pool, i.e. the actual using quantity <pool volume), it doesn't need to waste time to create and initialize a new process object sample, but allocate directly a process in process pool to user process, and set the attribute of” the process is from process pool or not” (IsProcessPoolProcess)of the process object to TRUE, add 1 to the actual using quantity variable, and return back its interface intellectual pointer. If the pre-created process object has been allocated in pool, the allocating method would create a new process object sample, and set the attribute of “the process is from process pool or not” (IsProcessPoolProcess)of the process object to FALSE, but both the actual using quantity and pool volume value is not changed and equals each other. The implicit volume value in present invention is 15, it is implicated in below that the created process is from process pool if no special notation. Of course the actual using quantity and pool volume value may be obtained first by user program, and re-set the pool volume value according to requirement for deciding if the created new process is from the process pool.

Through the said method, the user program may obtain a interface intellectual pointer pointing to a process object after creating a new process, and now exists already a clean operative process environment, however the process hasn't actually operated now, for actual operation, the start method of process object should be invoked by this interface intellectual pointer as later explained.

On basis of said thought and technologies, the problem of long time process creating in present known computer operation system is resolved, the reason is: the system created a certain quantity of process object samples in process pool at beginning and initialized the relative environment, so when the creating process (ISystem::CreateProcess( )) method is invoked by user program, it may be fetched directly, the “fetch” here merely means a assignment and dispatch of pointer. The system operates actually when user invokes the starting method, the system could utilize the time between process creating and process operating to handle other tasks, and before the program actually operating, user could make self-defining of operation environment according to requirement by the obtained interface intellectual pointer, including order line parameter, environment variable, private key setting. In this way, the system operation efficiency is improved and the safety managing to system and process operation from user is realized.

In case of user want to stop the process operation, it needs to invoke the stop operation function method of interface intellectual pointer, now the system merely make the process operation stopped, but don't release the resource of process object at once yet, and user may access its attribute still; for actually exiting from process and give back the occupied resource, it needs to invoke the stop object function method, now, the system would invoke the release method of process managing assembly to arrange the process environment, and release the relative resource. In the release method, it judges first the pieces of process object in pool, if actual using pieces=0, the system resource occupied by all the process object is needed to release, otherwise don't need waste time to release the whole process object, but arrange some environment parameters with the implication mode, put it into the process pool, and execute the operation of actual using pieces minus 1, so as to re-use the same process object environment to execute other application program later, thus the system time occupied by repeat creating/exiting from process is saved.

The designing and realization thought of thread pool managing assembly are same as the process pool with main difference as: the process pool is attributed to system, and the whole system may be a process pool managing assembly, but the thread pool is attributed to process, each concrete process object has one and only one thread pool managing assembly. In creating a process object, the thread pool managing assembly is created at same time, it has the property of pool buffer storage, manages a thread object buffer storage queue, and manages the resource and operation state of each thread object within the process object. In this thread pool managing assembly, certain pieces of thread object have been created in advance, and the environments needed for the operation are set in default mode, mainly including: creating a stack, a control block including the context, allocating the address space and code module in process, and the basic attributes of thread object in pool are set in default way, e.g. the schedule priority of thread. The so called “pieces” could be statically set by modifying head file or setting file, or be dynamically set by system function invoking, it is called “thread pool volume” in program designing. Similar to the process pool managing assembly, the thread pool managing assembly has at least two element methods of allocating and releasing also, and two element variables of pool volume and actually utilizing pieces as explained below.

The managing to an object in pool from the thread pool managing assembly is realized through a queue maintaining, and the thread object is an element of the queue. Two methods are provided in present invention for user creating a thread, i.e. one is invoking the system API function (ZeeCreateThread ( )), and another is creating through the interfacing method (IProcess? CreateThread ( )) of current process object. When the user program is executed to where of creating thread function/method, the system not creates directly a thread object, but allocates dynamically a usable thread object sample by the thread pool managing assembly allocation method. The realization mode of allocation method is: check first if there is any thread initialized but not actually used yet in the thread pool, if has any one (the allocated thread object sample quantity in pool <maximum thread sample quantity in pool, i.e. the actual using quantity <pool volume), it doesn't need to waste time to create and initialize a new thread object sample, but allocate directly a thread in thread pool to user thread, and set the attribute of “the thread is from thread pool or not” (IsThreadPoolThread)of the thread object to TRUE, add 1 to the actual using quantity variable, and return back its interface intellectual pointer. If the pre-created thread object sample has been allocated in pool, the allocating method would create a new thread object sample, and set the attribute of “the thread is from thread pool or not” (IsThreadPoolThread)of the thread object to FALSE, but both the actual using quantity and pool volume value is not changed and equals each other. For example, the implicit volume value is 15. It is implicated that all the created threads are from thread pool. Of course the actual using quantity and pool volume value may be obtained first by user program, and re-set the pool volume value according to requirement for deciding if the created new thread is from the thread pool.

Through the said method, the user program may obtain a interface intellectual pointer pointing to a thread object after creating a new thread, and now exists already a clean operative thread environment, however the thread hasn't actually operated now, for thread actual operation, the starting method of thread object should be invoked by this interface intellectual pointer as later explained.

On basis of said thought and technologies, the problem of long time thread creating in present known computer operation system is resolved, the reason is: a corresponding thread pool managing assembly was created in time of process creating, a certain quantity of thread object samples are created in thread pool, and initialized the relative environment, so when the creating thread (IProcess::CreateThread ( )) method is invoked by user program, it may be fetched to use directly, and the “fetch” here merely means a assignment and dispatch of pointer. The code is operated actually when user invoking the starting method, the system could utilize the time between thread creating and code executing to handle other tasks, and before the code is actually executed, user could make self-defining of operation environment according to requirement with the obtained interface intellectual pointer, including order line parameter, environment variable, private key setting. In this way, the system operation efficiency is improved and the safety managing to system and thread operation from user is realized.

In case of user want to stop the thread operation, it needs to invoke the stop operation function method of interface intellectual pointer, now the system merely make the thread execution stopped, but not release the resource of thread object at once yet, and user may access its attribute still; for actually exiting from thread and give back the occupied resource, it needs to invoke the stop thread object method, now, the system would invoke the release method of thread managing assembly to arrange the thread environment and release the relative resource. In the release method, it judges first the pieces of thread object in pool, if the actual using pieces=0, the system resource occupied by all the thread object is needed to released, otherwise don't need waste time to release the whole thread object, but arrange some environment parameters with the implication mode, put it into the process pool, and execute the operation of actual using pieces minus 1, for re-using the same thread object environment to execute other application program later, thus the system time occupied by repeat creating/exiting from thread is saved.

As above mentioned, present invention provides a computer technology realizing the process pool and thread pool managing function in operation system kernel, it could realize the safety and rapid creating/running/exiting from process/thread, the system time utilizing efficiency could be improved.

Both the process pool and thread pool managing technology provided by present invention is realized in component oriented programming environment. The system realizes a package to standard interface class, the complicated detail of COM component object invoking is covered, the user programming of local/remote creating/accessing/exiting from the process/thread is simplified, and has ability of independent component upstage, local/remote transparency, independent programming language.

### BRIEF DESCRIPTION OF THE APPENDED DRAWINGS

FIG. 1 is an illustrative view showing the usage and position of process pool managing assembly and thread pool managing assembly in present invention.

FIG. 2a is a structure figure of process pool managing assembly in present invention.

FIG. 2b is a structure figure of thread pool managing assembly in present invention.

FIG. 3a to FIG. 3c is the work steps comparison figure of creating/exiting from process between the present known operation system and the operation system utilizing the process pool managing assembly; wherein FIG. 3a is a work steps of process creating in known system; FIG. 3b is a work steps of create/exit from the process in present invention; FIG. 3c is a steps of exiting from process in known operation system.

FIG. 4a to FIG. 4c is the work steps comparison figure of creating/aborting the thread between the present known operation system and the present invention operation system utilizing the thread pool managing assembly; wherein FIG. 4a is the steps of thread creating in present known system; FIG. 4b is a work step of create/exit from the thread in present invention; FIG. 4c is the steps of exiting from thread in present known operation system.

FIG. 5 is the figure of relation between the program flow of creating/executing/exiting from the process and the process managing assembly in present invention.

FIG. 6 is the figure of relation between the program flow of creating/executing/exiting from the thread and the thread managing assembly in present invention.

### DETAILED DESCRIPTION OF THE INVENTION

Next, a further description of technology and effects in present invention will be made as to the present invention with the Figures and concrete embodiment. Refer to FIG. 1, the concept of process and thread exists in any computer operation system and is very important, the process and thread managing modes affect directly the operation efficiency and the realizable service function of system. In present invention, process pool managing assembly/thread pool managing assembly is a system managing assembly for improving the system time efficiency, and is mainly for the creating and releasing of system process object/thread object, on basis of creating a process pool /thread pool, a object may be fetched directly from pool in requirement and the efficiency is thus improved; on the other hand, with its buffer storage property, the process object/thread object which has been stopped but not releasing its resource yet may be accessed, and provide user for the required system information.

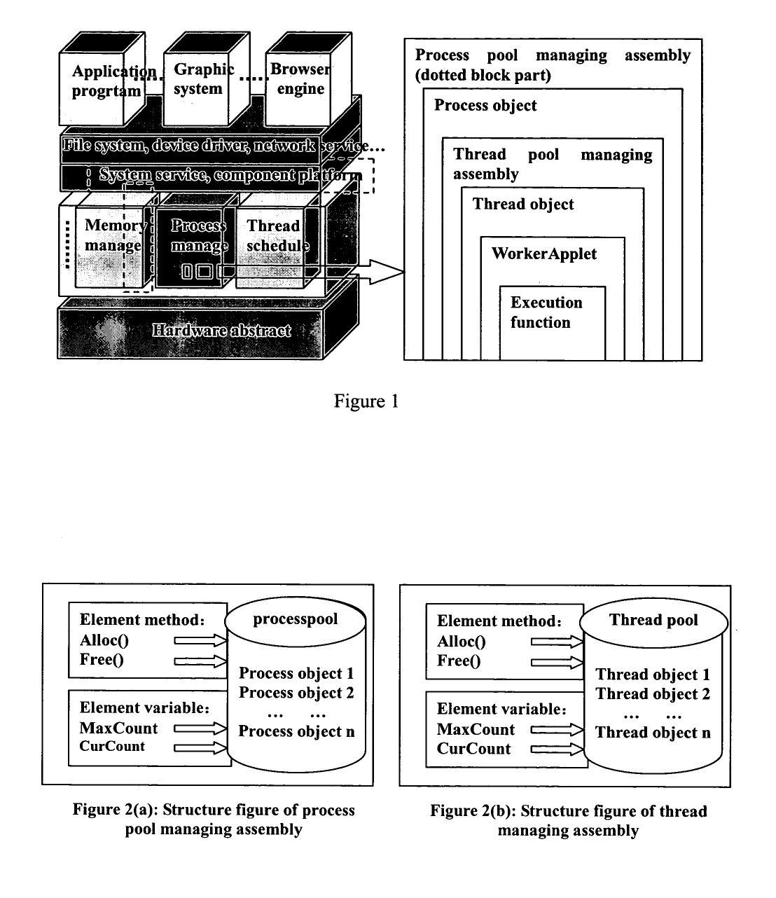

Refer to FIG. 2, the process pool managing assembly is similar to thread pool managing assembly, both has at least : two element methods of dispatching and releasing; two element variables of actual using quantity and pool volume; and a process pool /thread pool, the pool has certain quantity of process object samples/thread object samples.

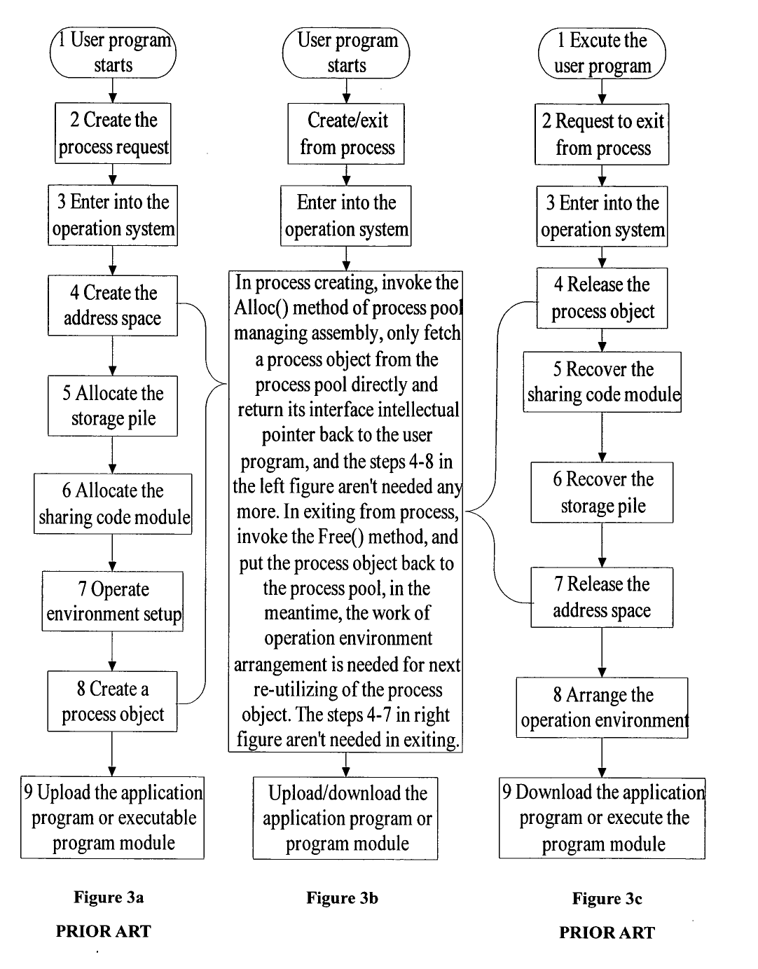

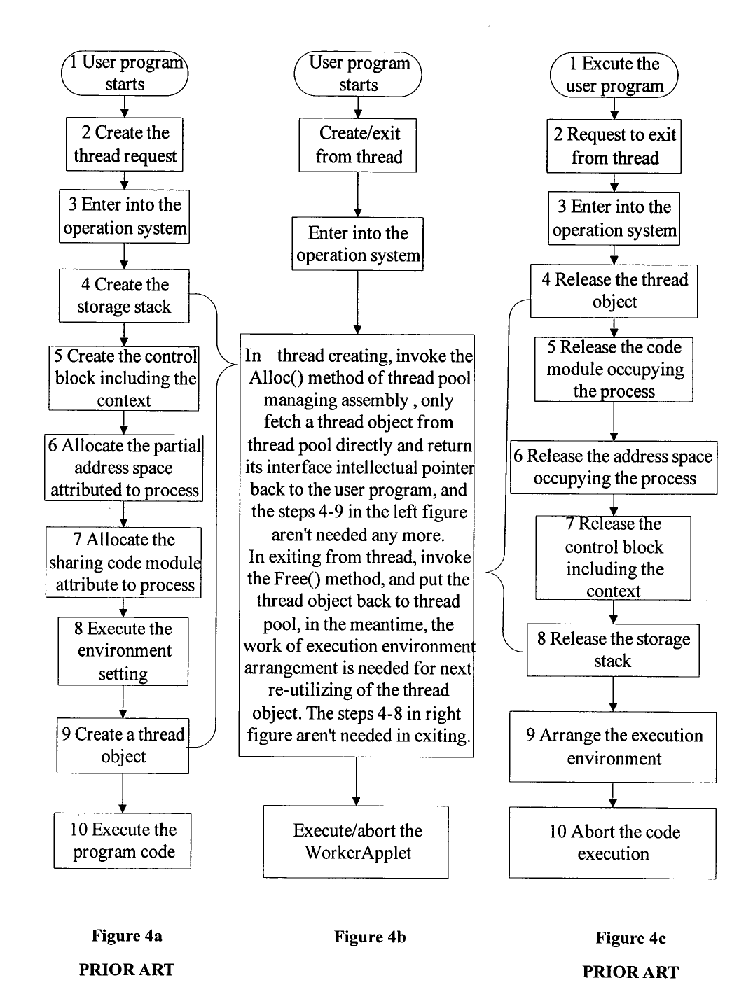

Refer to FIG. 3, FIG. 4, by the work steps comparison of creating/exiting from process between the present known operation system and the present invention operation system utilizing the process pool managing assembly, it may be seen: in process creating, if actual using quantity <pool volume, don't waste time to create a new process object sample, but fetch a process object from the pool directly and return back its interface intellectual pointer; in exiting from process, if the actual using quantity>0, don't waste time to release the object, but put it back to the pool for further utilizing. The creating/exiting from thread principle in FIG. 4 is same as FIG. 3.

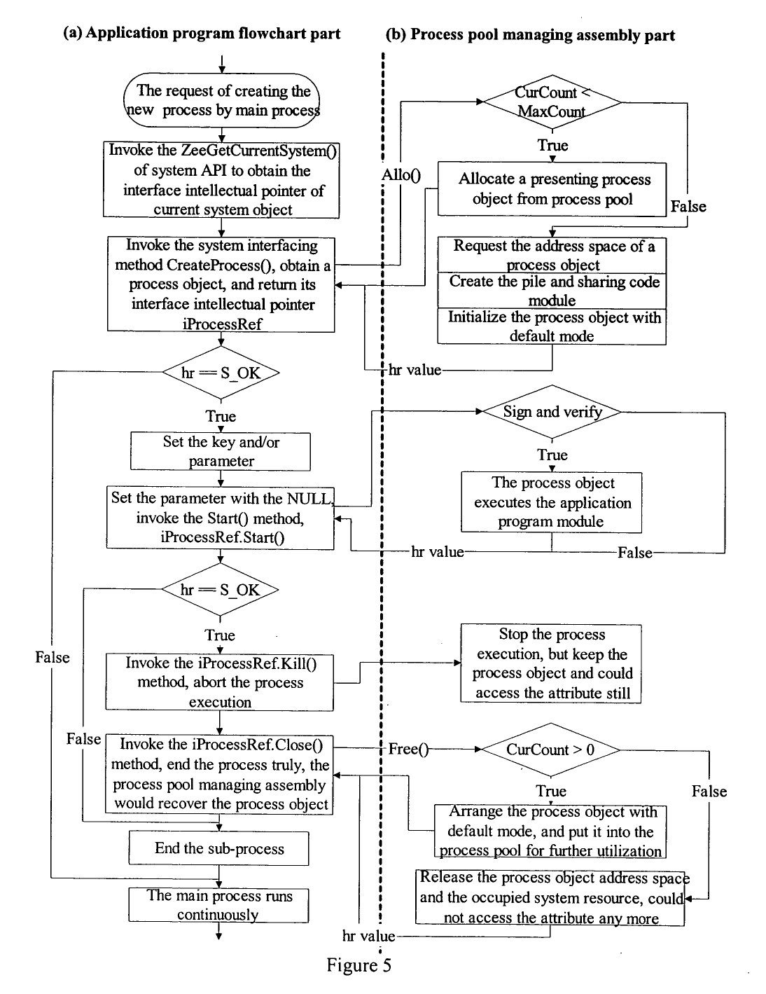

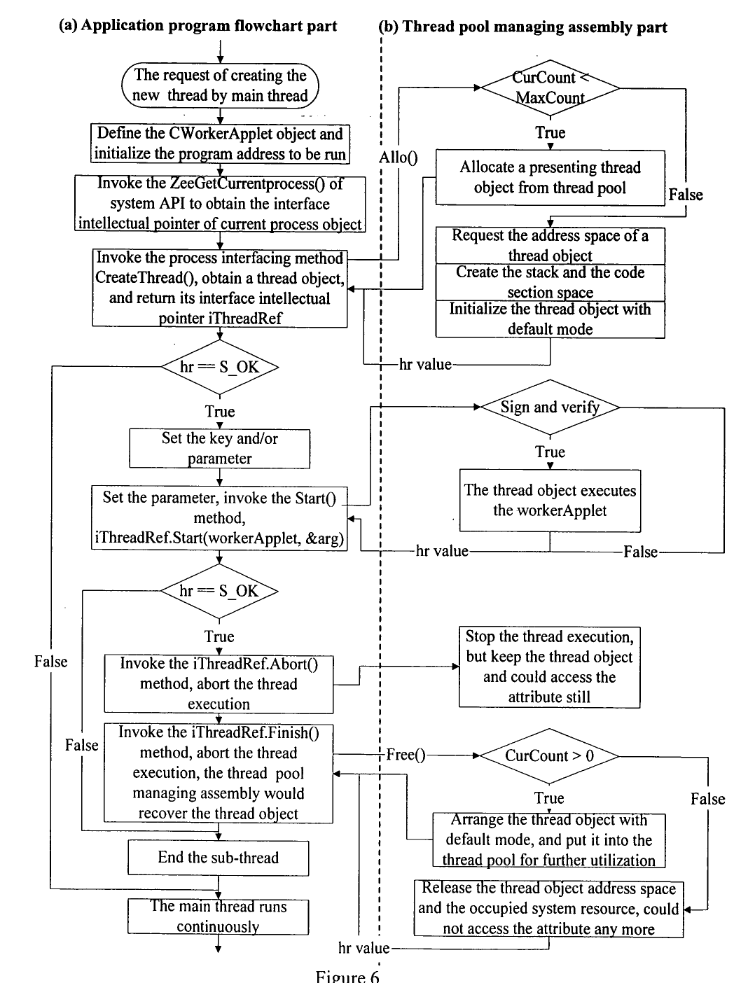

Refer to FIG. 5, i.e. concrete embodiment example in present invention: creating/executing/exiting from process in present invention. FIG. 5(a) is an application program flowchart, FIG. 5(b) indicates the role of process pool managing assembly in the course. The main procedure in the embodiment is as follows:

From the application program viewpoint:

Step 1: obtain the interface intellectual pointer of current system with system API function;

Step 2: invoke the system interfacing method, obtain a new process object, and return the interface intellectual pointer pointing to the new created process object;

Step 3: judge if the new process object is successfully created in step 2, i.e. if the hr value is successful, it is generally successful apart from abnormal system, and this step doesn't affect the program operation, but if it is system program, it is better to have a check to avoid abnormal;

Step 4: set the key and /or parameter, invoke the starting method of new created process object to actually operate the program, the starting includes the application program name needed for new process operating, executing program parameter, starting process mark, interface intellectual pointer pointing to a component object and program work category, the parameter designation includes some marks of process creating, and are used for transferring the special private key, order parameter and environment variable;

Step 5: invoke the process object, and confirm if it is a process object from process pool; whether it is from pool or not, user could set /obtain the relative data by invoking any method provided by the process object;

Step 6: invoke the stopping operation function of new created process object to stop the process operation, but the process object isn't released at once, and its attribute could be accessed still, e.g. in this embodiment, by invoking the method of process number obtaining, the process number may be obtained still;

Step 7: Invoke the stopping object function of new created process object to exit from the process operation, give back the process object and its attribute couldn't be accessed later.

From the system viewpoint: the character of present invention is: rather than creating a new process object directly in step 2, but invoke the allocating method of process pool managing assembly to fetch a usable process object from process pool directly (if actual using quantity<pool volume), and this saves the system occupying time. In step 7, the control right is transferred to the process pool managing assembly from the ending object function, it doesn't release directly the occupied system resource, but invoke the process pool managing assembly releasing method to handle it, if the actual using quantity in current pool>0, it doesn't need to release all the resources, but arrange partial environment parameters, and put them into pool for further utilizing, and this is also reduces the system occupying time.

Refer to FIG. 6, i.e. the concrete thread creating/exiting embodiment in present invention. FIG. 6(a) is a application program flowchart part, FIG. 6(b) indicates the role of thread pool managing assembly in this course. The main procedures in the embodiment are:

From user view point:

Step 1: Define a work course object, it needs to define two functions of function and ending in advance, and is initialized as two element methods of object respectively by invoking the invoking back function. In process execution starting, the code in action function is executed, in execution ending, the code in ending function is executed;

Step 2: Invoke system API function to obtain the interface intellectual pointer of current process object;

Step 3: Invoke the thread creating method of process interface, obtain a new thread object, and return the interface intellectual pointer pointing to the new created thread object;

Step 4: Judge if the new thread object is successfully created in step 3, i.e. if the hr value is successful, it is generally successful apart from abnormal system, and this step doesn't affect the program operation;

Step 5: Invoke the starting function of new created thread object to actually execute the code, after starting, operate the relative work routine, and verify the system according to the transferred key and /or parameter, and decide if providing service or not;

Step 6: Invoke the new created thread object, and confirm if it is a thread object from thread pool; user could set /obtain the relative data by invoking any method provided by the thread object;

Step 7: Invoke the stopping operation function of new thread object to stop the thread operation, but the system keeps the one time invoking of thread object, and don't release the thread object at once, and could access its attribute still, e.g. by invoking the method of thread number obtaining, the thread number may be obtained still;

Step 8: Invoke the stopping function of new thread object, now the system would actually end the thread execution, and give the thread object to the thread pool managing assembly to handle, and couldn't access its attribute later.

From the system viewpoint: the character of present invention is: if utilize a object, the object would be created in the defining in step 1, in the thread creating in step 3, rather than creating a new thread object directly, but invoke the allocating method of thread pool managing assembly to fetch a usable thread object from thread pool directly (if actual utilizing quantity<pool volume), and this saves the system occupying time. In step 8, the control right is transferred to the thread pool managing assembly from ending function, it doesn't release directly the occupied system resource, but invoke the thread pool managing assembly releasing method to handle it, if the current pool utilizing quantity>0, it doesn't need to release all the resources, but arrange partial environment parameters, and put it into pool for further utilizing, and this is also reduces the system occupying time.

We claim:

1. A component. oriented and system kernel based process pool /thread pool manage method, characterized in that:
The thread pool manage assembly is set in computer operation system kernel for managing the component-wise thread object stored in system thread pool, the managing includes the setup of operation environment suitable to thread object; each thread operates a work routine object in component oriented environment.

2. A component oriented and system kernel based process pool /thread pool manage method accord to claim 1, characterized in that:
The process pool manage assembly is also set in computer operation system kernel for managing the process object stored in system process pool, and setting up the operation environment suitable to process object.

3. A component oriented and system kernel based process pool /thread pool manage method accord to claim 2, characterized in that:
The process pool managing assembly/thread pool managing assembly are set in the bottom layer of operation system, in accordance with the storage managing mechanism, set the process pool /thread pool volume, provide the process pool/thread pool space, create a certain quantity of process object/thread object, and optimize the overall system property.

4. A component oriented and system kernel based process pool /thread pool manage method accord to claim 3, characterized in that:
The process pool managing assembly/thread pool managing assembly are orienting to all the system programs and application programs, and provides the management of obtaining the process object /thread object from operation system kernel directly for improving the system efficiency.

5. A component oriented and system kernel based process pool /thread pool manage method accord to claim 4, characterized in that:
The setting includes mainly requiring a section of address space for object, creating the storage pile and stack, generating the shared code module, and setting the object basic attribute in default way.

6. A component oriented and system kernel based process pool /thread pool manage method accord to claim 5, characterized in that:
The default way setting includes: the schedule priority of process /thread, the process object/thread object is from process pool /thread pool or not, and the system key generated cording to the current environment.

7. A component oriented and system kernel based process pool /thread pool manage method accord to claim 4, characterized in that:
The process pool managing assembly is structured in the initialization stage of operation system kernel, the certain quantity of process objects are created in advance, and the thread pool managing assembly is created at the same time of setting a process object.

8. A component oriented and system kernel based process pool /thread pool manage method accord to claim 7, characterized in that:
There are one or more process pool managing assemblies in whole system, one or more thread pool managing assemblies are set for each process object correspondingly.

9. A component oriented and system kernel based process pool /thread pool manage method accord to claim 4, characterized in that:
The process pool managing assembly manages all the resources needed to the process, creates the process, and records the attributes of each process; in exiting from process, recovers the using resources, for each process object, the thread pool managing assembly creates the thread object, manages the resource utilization of every thread attributed to this process, and records the attributes of each thread object, after thread execution, the thread pool managing assembly arranges the resource.

10. A component oriented and system kernel based process pool /thread pool manage method accord to claim 9, characterized in that:
The object recovering includes the partial environment parameters arranging, and putting it into the pool.

11. A component oriented and system kernel based process pool /thread pool manage method accord to claim 10, characterized in that:
The partial environment parameters include the system implication setup, system current user and its key, current work rout and order running parameter.

12. A component oriented and system kernel based process pool/thread pool manage method accord to claim 9, characterized in that:
When the application program requires the object creating, an object is assigned directly from the pool, or a new object is created.

13. A component oriented and system kernel based process pool/thread pool manage method accord to claim 9, characterized in that:
After the process/thread execution is ended by application program, the pool managing assembly stores the one time invoking of the object and its resource, or arranges its operation environment, or releases the object.

14. A component oriented and system kernel based process pool/thread pool manage method accord to claim 13, characterized in that:
For the object and its resource stored in pool managing assembly, user may invoke its interfacing method to access its attribute.

15. A component oriented and system kernel based process pool/thread pool manage method accord to claim 13, characterized in that:
For the object and its resource that didn't be stored in pool managing assembly, it would be released, or put into the process pool/thread pool after arranging its operation environment, and the user couldn't access its attribute any more.

16. A component oriented and system kernel based process pool /thread pool manage method accord to claim 4, characterized in that:
The process pool or thread pool managing assembly includes at least two element methods of allocating and releasing, the system actualizes the creating/exiting exiting from the process/thread by invoking the relative method.

17. A component oriented and system kernel based process pool /thread pool manage method accord to claim 4, characterized in that:
Both process pool managing assembly/thread pool managing assembly stores at least the two element variables of pool volume and actual used quantity, they indicate respectively the maximum process object/thread object quantity pool could containing, and the process object/thread object quantity to be used currently.

18. A component oriented and system kernel based process pool /thread pool manage method accord to claim 17, characterized in that:
The objects in pool manage and operate in queue way, the actual utilizing quantity is changed according to the used object quantity in pool, i.e. actual utilizing quantity is increased or decreased.

19. A component oriented and system kernel based process pool /thread pool manage method accord to claim 17, characterized in that:
The user could obtain/set the volume of process pool/thread pool through system invoking.

20. A component oriented and system kernel based process pool /thread pool manage method accord to claim 19, characterized in that:
The pool volume could be statically set by modifying the head file or setting file, or be dynamically set by invoking the system function.

21. A component oriented and system kernel based process pool /thread pool manage method accord to claim 1, characterized in that:
When the application program requests the object creating, the process pool/thread pool managing assembly judges if the actual using quantity of process pool/thread pool is less than the pool volume, allocates directly a object from pool if yes; otherwise creates a new object.

22. A component oriented and system kernel based process pool/thread pool manage method accord to claim 1, characterized in that:
When the process/thread is ended by application function, the process pool/thread pool managing assembly judges if the actual using quantity is more than 0; the pool managing assembly puts the object directly into pool for further utilizing if yes; otherwise releases the object and its resource.

23. A component process /thread pool mode managing application program object obtaining and executing based method, characterized in that:
It includes: requiring of new process or thread creating by application program main process or main thread, invoking the system API or interface function, obtaining the interface intellectual pointer of current system object, invoking the relative interfacing method by the interface intellectual pointer, obtaining a sampled object, returning the interface intellectual pointer, setting parameter, invoking the starting method of new created object to run the program, invoking the ending method to stop the operation but keep the object, invoking the resource releasing method to actual release the object, ending the sub-process or sub-thread with the main process or main thread operating continuously.

24. A component process /thread pool mode managing application program object obtaining and executing based method accord to claim 23, characterized in that:
The process object/thread object is created by system/process interfacing method, in concrete, it may be the allocating method of invoking the process pool managing assembly/thread pool managing assembly, in case of actual using quantity<pool volume, a process object/thread object is fetched directly from process pool/thread pool and its interface intellectual pointer is returned back; in case of actual used quantity spool volume, a new process object/thread object is needed to be created.

25. A component process/thread pool mode managing application program object obtaining and executing based method accord to claim 23, characterized in that:
When exiting from process /thread execution and recovering the object, it may be the releasing method of invoking process pool managing assembly/thread pool managing assembly, in case of actual using quantity>0, it needs only to arrange the operation environment through the implication mode, and put it back to process pool/thread pool directly for further utilization; in case of the actual using quantity=0, the process object/thread object and all the occupied system resources are released.

26. A component process/thread pool mode managing application program object obtaining and executing based method accord to claim 23, characterized in that:
In case of ending the process/thread, the system stops the object operation, the pool managing assembly keeps the one time invoking of the object, and temporary stores the object and its resource, judges if release the object and its resource according to the set condition and the system storage managing mechanism.
